(19) United States
(12) Patent Application Publication
(10) Pub. No.: US 2021/0207395 A1
(43) Pub. Date: Jul. 8, 2021

(54) CONQUEST RANCH FENCING SYSTEMS AND METHOD

(71) Applicant: Gabriel Perez, Pleasanton, TX (US)

(72) Inventor: Gabriel Perez, Pleasanton, TX (US)

(21) Appl. No.: 16/734,335

(22) Filed: Jan. 5, 2020

(51) Int. Cl. E04H 17/12; E04H 17/04

(52) U.S. Cl. CPC E04H 17/12; A01K 3/00; E04H 17/04

(57) ABSTRACT

A safe and convenient way to secure barbed wire to fence posts. The system effectively prevents barbed wire from becoming loose over time, whether from repeated engagement with cows and bulls, weather, rain, and more. It significantly reduces fence maintenance. The product saves a considerable amount of time, allowing ranchers to tend to other responsibilities. The system alleviates the hassle of herding escaped cows and bulls back onto the fenced-in land.

### CROSS-REFERENCE TO RELATED APPLICATION(S)

The present application is related to and claims priority to U.S. Provisional Patent Application No. 62/748,264 filed Oct. 19, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fences of existing art and more specifically relates to braced fences.

### RELATED ART

Currently, ranchers use staple nails to secure barbed wire to wooden fence posts. Over time, the stable nails come completely out or become loose for a variety of reasons, including cows placing their head through the fence to eat grass on the other side, bulls leaning on the fence or pushing wire down to go after a cow in heat. Rain or other inclement weather may cause the wire to get loose in relation to the posts. Unfortunately, this can compromise the structural integrity of the entire fence, forcing expensive and time consuming repairs. A suitable solution is desired.

U.S. Pat. No. 4,708,323 relates to a fence of a type including two posts secured to the ground and at least two wires extending between the posts. One of the wires is spaced above the other by a predetermined distance. An elastomeric elongated member having a front edge, a rear edge parallel to the front edge, top and bottom edges and two parallel sides has a wire holding structure at the top and bottom ends thereof. A small slot associated with each wire holding structure has a length narrower than the diameter of the wire so that it must be deformed in order to get the wire therethrough. Consequently, the fence attachment can be snapped onto two strands of wire without a danger that it will come unfastened.

### SUMMARY OF THE INVENTION

In view of the foregoing disadvantages inherent in the known fences art, the present disclosure provides a novel fencing system. The general purpose of the present disclosure, which will be described subsequently in greater detail, is to provide a convenient and effective means to prevent animals from exiting a defined perimeter.

A fencing system is disclosed herein in a first embodiment, the system comprising: a wire-engager member for attachment to a vertical fence-post having a body defined by a front-side; a rear-side; a length; and a thickness; the body having a plurality of L-shaped receiver hooks lined in a column; and a plurality of apertures. The plurality of L-shaped receiver hooks run in vertical series on the front-side and along the length of the body; wherein each of the L-shaped receiver hooks is configured to removably receive wire strung between the vertical fence-posts; each wire-engager member mounted to the vertical fence-post via fasteners placed through the apertures. As such the wire is held taut (when tightened) between the vertical fence-posts to prevent animals from passing through the vertical fence-posts and escaping a defined perimeter.

The fencing system in a second embodiment is also disclosed herein, the system comprising: at least one wire-engager post configured (each) for use as a vertical fence-post having a wire-engager post-body having a t-shaped profile and defined by a proximal-end; a distal-end; a wire-engager post-length. The wire-engager post-body has a plurality of L-shaped receiver hooks lined in a column; wherein the plurality of L-shaped receiver hooks run in vertical series along the wire-engager post-length of the wire-engager post-body. Each of the L-shaped receiver hooks is configured to removably receive wire strung between the wire-engager posts. The wire is held taut between the wire-engager posts to prevent animals from passing through the wire-engager posts.

Methods of using the fencing system are also disclosed herein. A method for use of the first embodiment may comprise the steps of: fastening the wire-engager member to a vertical fence-post (via fasteners); stringing wire horizontally to, perpendicular to, and adjacent to the plurality of vertical fence-posts; inserting the wire into a corresponding one of a plurality of L-shaped receiver hooks; and tightening the wire until taut. Multiple wires are strung and tightened in a like manner to prevent animals from passing through the vertical fence-posts.

The method for use with the second embodiment comprises the steps of: driving a plurality of wire-engager posts through a planar ground surface into a ground-volume (solidly in place once driven), each of the wire-engager posts configured for use as a vertical fence-post; stringing wire horizontally next to, perpendicular to, and adjacent to the plurality of wire-engager posts; inserting the wire into a corresponding one of the plurality of L-shaped receiver hooks (to the bottom); and tightening the wire until taut. The method is repeated with multiple wires being strung, engaged, and tightened to prevent animals from passing through the wire-engager posts.

A kit is also described herein for the first embodiment including a plurality of wire-engager members; fasteners and an instruction manual for installation and use. A kit for the second embodiment may comprise a plurality of wire-engager posts and an instruction manual for installation and use. Wire may optionally be included as well with either kit.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fencing system, constructed and operative according to the teachings of the present disclosure.

FIG. 1 is a perspective view of the fencing system during an ‘in-use’ condition, according to a second embodiment of the disclosure.

FIG. 2 is another perspective view of the fencing system of FIG. 1 as used to contain animals within a confined area, according to a second embodiment of the present disclosure.

FIG. 3 shows side views of the fencing system of FIG. 1, as to illustrate driving the device through a planar ground surface into a ground volume, the distal end piercing the ground and entering to be positioned for use, according to the second embodiment of the present disclosure.

FIG. 4 shows views of the fencing system of FIG. 1, according to a first embodiment of the present disclosure, the views (from left to right) showing respectively: the wire-engager member for attachment to a vertical fence-post (side view); the rear-side of the wire-engager member and the wire-engager member as being installed to a wooden vertical fence-post.

FIG. 5 is a perspective view of the fencing system during an ‘in-use’ condition, as used to contain animals within a confined area, according to a first embodiment of the disclosure.

The various embodiments of the present invention will hereinafter be described in conjunction with the appended drawings, wherein like designations denote like elements.

### DETAILED DESCRIPTION

As discussed above, embodiments of the present disclosure relate to a braced fence and more particularly to a fencing system as used to improve the containment of animals within a particular defined area.

Generally, ‘Conquest Ranch Fencing’ (fencing system) helps ranchers effectively ensure their fence remains solid, structurally sound, and erect. This innovative product features a t-post, made from one solid piece of steel or other suitable material. On the bottom of the post can be a steel stake that drives into the ground. Along the height of the post can be a series of tight L-shaped grooves in which barbed wire can be hooked. The grooves can prevent the wire from ‘giving’ or collapsing under pressure. Optionally, a steel attachment that can be secured to existing wood posts may also be offered. The attachment version can have a series of grooves along its height for securing barbed wire. A fastener (nail, screw or the like) hole at the top of the attachment can be used to secure the attachment to the post.

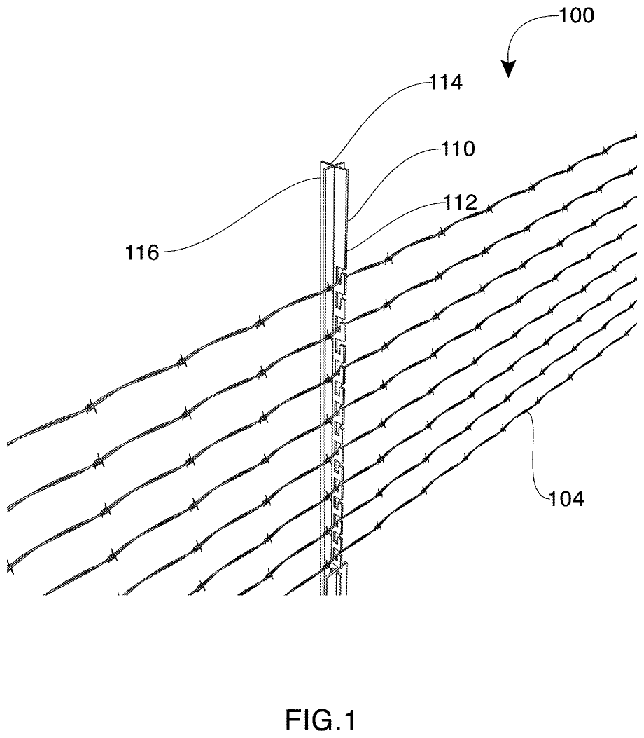

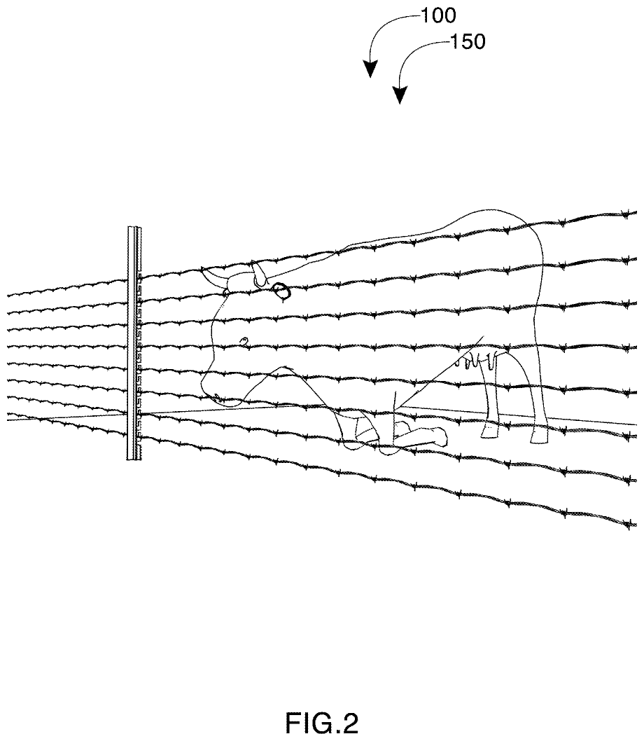

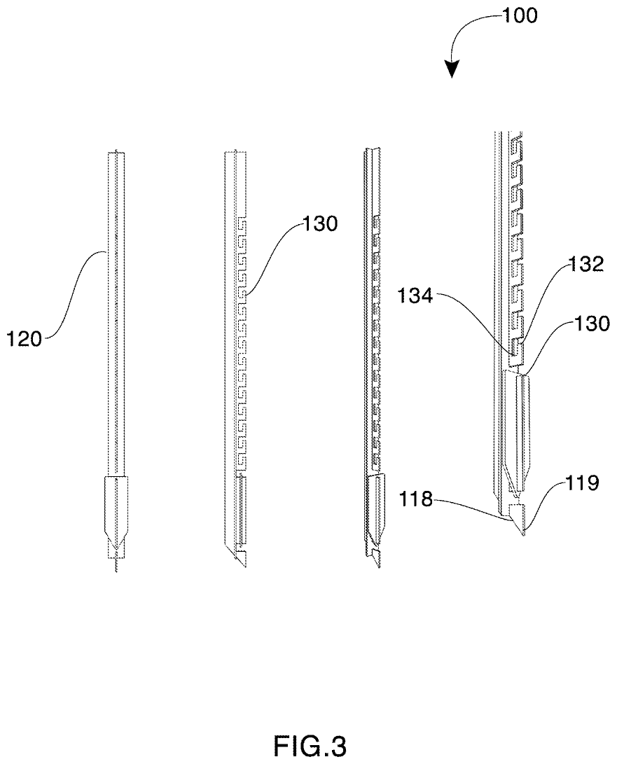

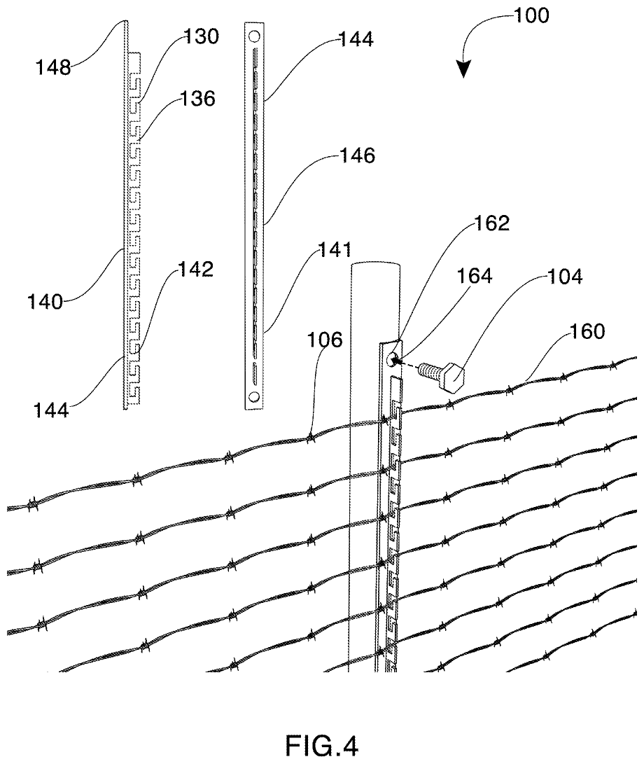

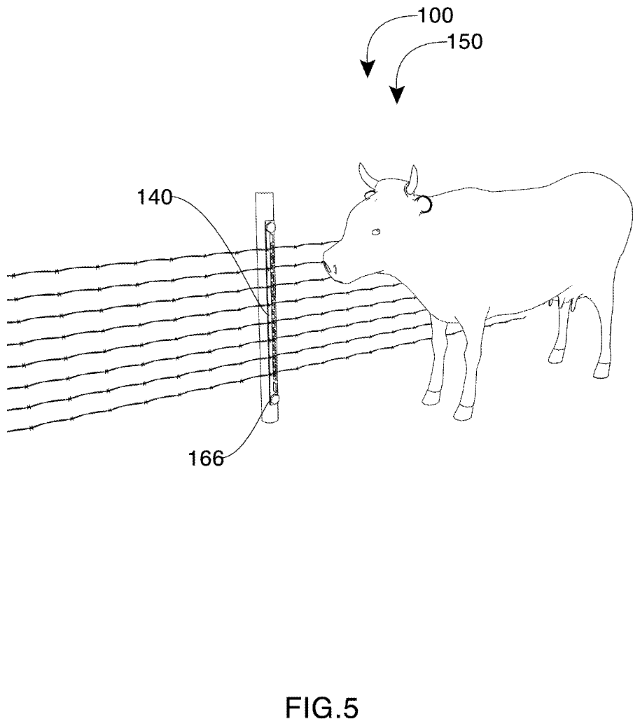

Referring now more specifically to the drawings by numerals of reference, there is shown in FIGS. 1-5, various views of a fencing system 100. FIGS. 1-3 show a second embodiment of fencing system 100; FIG. 1 showing a close-up view of barbed wire 104 running through grooves on the wire-engager post 110; FIG. 2 shows a cow attempting and failing to breach the wire 104; FIG. 3 shows how the steel stake as wire-engager post 110 drives into the ground; FIG. 4-5 show a first embodiment of the fencing system 100 and how the attachment version wire-engager members 140 is applied to a wood post; and FIG. 5 illustrates the wire-engager members 140 (first embodiment) in use 150, according to an embodiment of the present disclosure. Here, the fencing system 100 may be beneficial for use by a user to contain animals as shown in FIGS. 2 and 5. As illustrated, the fencing system 100 in a second embodiment may include: at least one wire-engager post 110 configured (each) for use as a vertical fence-post having a wire-engager post-body 112 having a t-shaped profile 114 (cross-shaped or the like) and defined by a proximal-end 116; a distal-end 118; and a wire-engager post-length 120. The wire-engager post-body 112 has a plurality of L-shaped receiver hooks 130 lined in a column; wherein the plurality of L-shaped receiver hooks 130 run in vertical series along the wire-engager post-length 120 of the wire-engager post-body 112. Each of the L-shaped receiver hooks 130 is configured to removably receive wire 104 strung between the wire-engager posts 110. The wire 104 is held taut between the wire-engager posts 110 to prevent animals such as cows from passing through the wire-engager posts 110.

FIG. 3 shows the distal-end 118 of the wire-engager post 110 comprising a pointed-tip 119; wherein the wire-engager post 110 is configured to be driven through a planar ground surface into a ground-volume.

A method of using the fencing system 100 (second embodiment) may comprise the steps of: driving a plurality of wire-engager posts 110 through a planar ground surface into a ground-volume (solidly in place once driven) as shown in FIG. 3, each of the wire-engager posts 110 configured for use as a vertical fence-post; stringing wire 104 (as unrolled from a wire-roll) horizontally next to, perpendicular to, and adjacent to the plurality of wire-engager posts 110; inserting the wire 104 into a corresponding one of the plurality of L-shaped receiver hooks 130 (to the bottom); and tightening the wire 104 until taut. This method is able to be repeated with multiple wires 104 being strung, engaged, and tightened to prevent animals from passing through the wire-engager posts 110 as shown in FIG. 2.

A kit for the second embodiment may comprise a plurality of wire-engager posts 110 and an instruction manual for installation and use. The instructions may detail functional relationships in relation to the structure of the fencing system 100 such that the fencing system 100 can be used, maintained, or the like, in a preferred manner. A kit is also described herein for the first embodiment including a plurality of wire-engager members 140; fasteners 160 and an instruction manual for installation and use. Wire 104 may optionally be included as well with either kit.

FIG. 4 shows views of the fencing system 110 according to a first embodiment of the present disclosure, the views (from left to right) showing respectively: the wire-engager member 140 for attachment to a vertical fence-post (side view); the rear-side 144 of the wire-engager member 140 and the wire-engager member 140 as being installed to a wooden vertical fence-post. FIG. 5 is a perspective view of the fencing system 100 during an ‘in-use’ condition 150, as used to contain animals within a confined area.

FIGS. 4-5 show the fencing system 100 in a first embodiment (attachable version), the system comprising: a wire-engager member 140 for attachment to a vertical fence-post having a body 141 defined by a front-side 142; a rear-side 144; a length 146; and a thickness 148; the body 141 having a plurality of L-shaped receiver hooks 130 lined in a column; and a plurality of apertures 162. The plurality of L-shaped receiver hooks 130 run in vertical series on the front-side 142 and along the length 146 of the body 141; wherein each of the L-shaped receiver hooks 130 is configured to removably receive wire 104 strung between the vertical fence-posts. Each wire-engager member 140 is able to be mounted to the vertical fence-post via fasteners 160 (FIG. 4) placed through the apertures 162. As such the wire 104 is held taut (when tightened) between the vertical fence-posts to prevent animals from passing through the vertical fence-posts and escaping a defined perimeter as shown in FIG. 5.

As shown in FIG. 4 the rear-side 144 of the body 141 of the wire-engager member 140 is adjacent the vertical fence-post during use. The plurality of L-shaped receiver hooks 130 comprises at least three of the L-shaped receiver hooks 130 in either embodiment of fencing system 100 as shown in FIGS. 1, 3 and 4. Each of the apertures 162 (of the first embodiment) are located through the thickness 148; wherein the plurality of apertures 162 comprises at least a top-aperture 164 and a bottom-aperture 166. The top-aperture 164 is located above the plurality of the L-shaped receiver hooks 130 during an in-use condition 150 and the bottom-aperture 166 is located below the plurality of the L-shaped receiver hooks 130 during an in-use condition 150 as shown in FIGS. 4-5.

The L-shaped receiver hooks 130 each comprise an ingress-egress-leg 132 and a holding-leg 134; wherein the holding-leg 134 is longer than the ingress-egress-leg 132. The ingress-egress-leg 132 is substantially horizontal (and relationally speaking above holding-leg 134) when in an in-use condition 150. The holding-leg 134 is substantially vertical when in an in-use condition 150. The holding-leg 134 and the ingress-egress-leg 132 share an integral channel 136. The wire 104 sits adjacent a bottom of the holding-leg 134 when in an in-use condition 150. The wire 104 may comprise barbs 106 and the barbs 106 cannot pass through the holding-leg 134 of the L-shaped receiver hooks 130.

A method for use of the first embodiment may comprise the steps of: fastening the wire-engager member 140 to a vertical fence-post (via fasteners 160); stringing wire 104 horizontally to, perpendicular to, and adjacent to the plurality of vertical fence-posts; inserting the wire 104 into a corresponding one of a plurality of L-shaped receiver hooks 130; and tightening the wire 104 until taut. Multiple wires 104 may be strung and tightened in a like manner to prevent animals from passing through the vertical fence-posts as shown in FIG. 5.

It should be noted that the steps described in the methods of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for installing and using fencing system 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fencing system, the system comprising:
a wire-engager member for attachment to a vertical fence-post having
a body defined by
a front-side;
a rear-side;
a length; and
a thickness;
said body having
a plurality of L-shaped receiver hooks lined in a column; and
a plurality of apertures;
wherein said plurality of L-shaped receiver hooks run in vertical series on said front-side and along said length of said body; and
wherein each of said L-shaped receiver hooks is configured to removably receive wire strung between said vertical fence-posts, each said wire-engager member mounted to said vertical fence-post via fasteners placed through said apertures, said wire is held taut between said vertical fence-posts to prevent animals from passing through said vertical fence-posts.

2. The fencing system of claim 1, wherein said rear-side of said body of said wire-engager member is adjacent said vertical fence-post during use.

3. The fencing system of claim 1, wherein said plurality of said L-shaped receiver hooks comprises at least three of said L-shaped receiver hooks.

4. The fencing system of claim 1, wherein each of said apertures are located through said thickness.

5. The fencing system of claim 1, wherein the plurality of apertures comprises at least a top-aperture and a bottom-aperture.

6. The fencing system of claim 5, wherein the top-aperture is located above said plurality of said L-shaped receiver hooks during an in-use condition.

7. The fencing system of claim 5, wherein the bottom-aperture is located below said plurality of said L-shaped receiver hooks during an in-use condition.

8. The fencing system of claim 1, wherein the L-shaped receiver hooks each comprise an ingress-egress-leg and a holding-leg.

9. The fencing system of claim 8, wherein the holding-leg is longer than said ingress-egress-leg.

10. The fencing system of claim 9, wherein the ingress-egress-leg is horizontal when in an in-use condition.

11. The fencing system of claim 9, wherein the holding-leg is vertical when in an in-use condition.

12. The fencing system of claim 9, wherein the holding-leg and said ingress-egress-leg share an integral channel.

13. The fencing system of claim 9, wherein the wire sits adjacent a bottom of said holding-leg when in an in-use condition.

14. The fencing system of claim 13, wherein the wire comprises barbs and said barbs cannot pass through the holding-leg of said L-shaped receiver hooks.

15. The fencing system of claim 1, further comprising a set of instructions; and
wherein the fencing system is arranged as a kit.

16. The fencing system, the system comprising:
a wire-engager post configured for use as a vertical fence-post having
a wire-engager post-body having a t-shaped profile and defined by
a proximal-end;
a distal-end;
a wire-engager post-length; and
said wire-engager post-body having a plurality of L-shaped receiver hooks lined in a column; and
wherein said plurality of L-shaped receiver hooks run in vertical series along said wire-engager post-length of said wire-engager post-body; and
wherein each of said L-shaped receiver hooks is configured to removably receive wire strung between said wire-engager posts, said wire is held taut between said wire-engager posts to prevent animals from passing through said wire-engager posts.

17. The fencing system of claim 16, wherein said distal-end comprises a pointed-tip.

18. The fencing system of claim 17, wherein said wire-engager post is configured to be driven through a planar ground surface into a ground-volume.

19. A method of using a fencing system, the method comprising the steps of:
driving a plurality of wire-engager posts through a planar ground surface into a ground-volume, each of said wire-engager posts configured for use as a vertical fence-post;
stringing wire horizontally to, perpendicular to, and adjacent to said plurality of wire-engager posts;
inserting said wire into a corresponding one of a plurality of L-shaped receiver hooks; and
tightening said wire until taut.

20. The method of claim 19, wherein a plurality of said wires are strung and tightened to prevent animals from passing through said wire-engager posts.
